(19) United States
(12) Patent Application Publication
(10) Pub. No.: US 2019/0283300 A1
(43) Pub. Date: Sep. 19, 2019

(54) DIE CASTING MACHINE AND METHOD FOR OPERATING THE SAME

(71) Applicant: Honda Motor Co., Ltd., Tokyo (JP)

(72) Inventors: Don Rethman, Jackson Center, OH (US); Ryan M. Goettemoeller, Sidney, OH (US)

(21) Appl. No.: 15/924,858

(22) Filed: Mar. 19, 2018

(51) Int. Cl. B29C 47/92; B22C 9/06; B22D 17/22; B22D 17/32

(52) U.S. Cl. CPC B29C 47/92; B22C 9/065; B22D 17/2218; B22D 17/32; B22D 17/26; B29C 2947/926; B29C 2947/92209; B29C 2947/92104; B22D 17/2236; B29C 2947/92704

(57) ABSTRACT

A die casting machine is provided that includes a controller, a casting mold, and a material injection system. A method for operating the die casting machine is provided that includes detecting a downtime event using a controller, determining a length of time between a beginning of the downtime event and an end of the downtime event, determining a number of preheat castings to produce in a preheat cycle, and transmitting a signal instructing the casting mold and the material injection system to produce the number of preheat castings.

### BACKGROUND

In automobile manufacturing, various methods of metal fabrication are used to produce metal components, such as stamping, forming, extruding, and die casting. Die casting, in particular, is a process wherein molten metal is fed into a mold cavity of a die casting machine to form a casting that is then held in the mold cavity until the casting cools and fully solidifies. Die casting is most often used to produce components that include non-ferrous metal alloys including zinc, copper, aluminum, magnesium, lead, pewter, and tin. An aluminum engine block is an example of an automobile component that is often produced using a die casting operation.

When a casting is produced using a typical die casting process, the casting will contain a small amount of defects called porosity, which are small voids in the casting. A quality specification for a specific component will often specify a maximum level of porosity that can be contained in its casting. The level of porosity of a casting can be measured by various testing methods including weight measurement and x-ray testing.

Porosity can be attributed to a number of factors, including gasification of impurities due to a high temperature, sharp changes in a mold cavity temperature, die casting machine shot speed, and part design. Sharp changes in the mold cavity temperature, in particular, is often a factor that can be readily controlled or accounted for in a manufacturing environment. However, while the mold cavity temperature may be controllable by the die casting machine during a continuous production operation, if the die casting machine is not operating or receiving power for a period of time, such as during a downtime event wherein a production line is shut down, the mold cavity temperature may decrease to an extent that negatively affects the quality of the casting.

Following a downtime event, one method of increasing the mold cavity temperature to a level that produces an acceptable component involves producing a preheat casting. The preheat casting is different from a production casting in that the molten metal is forced into the mold cavity at a slower rate, and the casting is produced in a manner wherein it is more easily recyclable than the production casting. Often a manufacturing associate is tasked with manually analyzing the duration of the downtime event and instructing the die casting machine to produce a specific number of preheat castings. This manual analysis and instruction of the number of preheat castings introduces an element of human error that can result in an insufficient number of preheat castings being produced that could subsequently lead to an unacceptable production casting, or an excess number of preheat castings being produced leading to excess waste.

### BRIEF SUMMARY

According to one aspect, a method for operating a die casting machine is provided. The method includes detecting a downtime event using a controller, determining a length of time, determining a number of preheat castings to produce in a preheat cycle, and transmitting a signal. The die casting machine includes a controller, a casting mold, and a material injection system. The length of time is between a beginning of the downtime event and an end of the downtime event. The signal instructs the casting mold and the material injection system to produce the number of preheat castings.

According to another aspect, a die casting machine is provided. The die casting machine includes a casting mold, a material injection system, and a controller. The material injection system is in flow communication with the casting mold and configured to provide molten material to the casting mold. The controller is in signal communication with the material injection system and configured to detect a downtime event, determine a length of time between a beginning of the downtime event and an end of the downtime event, determine a number of castings to produce in a preheat cycle, and transmit a signal instructing the casting mold and the material injection system to produce the number of castings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic view of a die casting machine according to an exemplary embodiment.

FIG. 2 is a method for operating a die casting machine according to an exemplary embodiment.

FIG. 3 is a method for determining a number of preheat castings according to an exemplary embodiment.

FIG. 4 is a chart illustrating a length of time vs. a casting mold temperature according to the method provided in FIG. 3.

### DETAILED DESCRIPTION

### Description

With reference now to the figures wherein the illustrations are for purposes of illustrating one or more exemplary embodiments and not for purposes of limiting the same, there is shown a die casting machine and method for operating the same.

Drawings

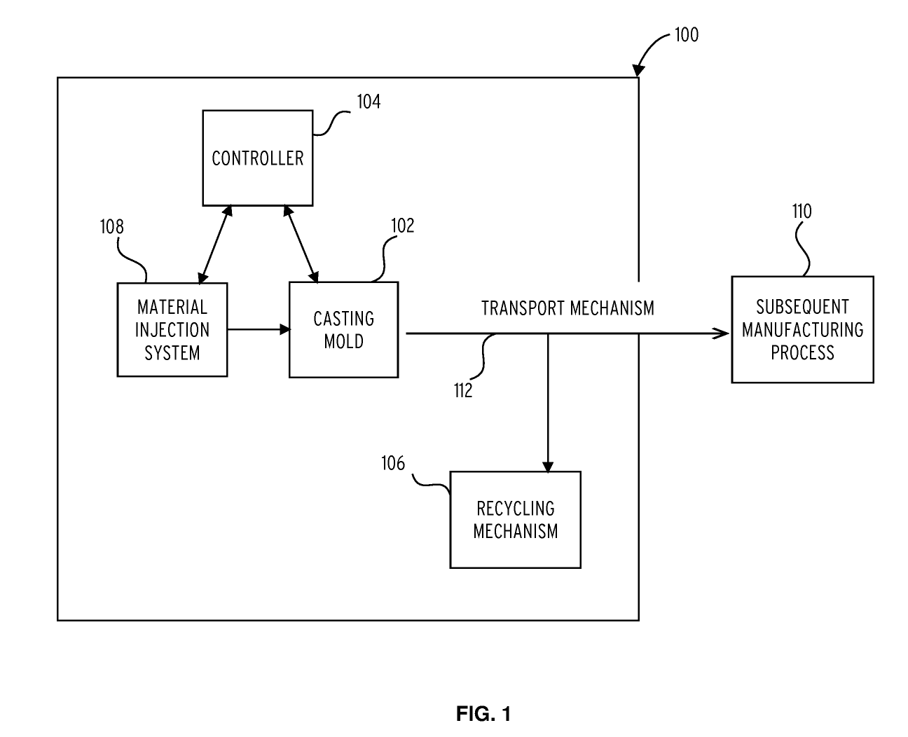

FIG. 1 is a schematic view of a die casting machine 100. In an exemplary embodiment, the die casting machine 100 includes a controller 104, a material injection system 108, a casting mold 102, a transport mechanism 112, and a recycling mechanism 106. The embodiment depicted in FIG. 1 also includes a subsequent manufacturing process 110. The die casting machine 100 receives molten metal and forces it into the casting mold 102 via the material injection system 108. The molten metal is left to cool and harden within the casting mold to form a casting, which is then removed from the casting mold 102 and transported to either the subsequent manufacturing process 110 or the recycling mechanism 106.

The controller 104 is in signal communication with the material injection system 108 and the casting mold 102 and is configured to detect a downtime event, determine a length of time between a beginning of the downtime event and the end of the downtime event, determine a number of castings to produce in a preheat cycle, and transmit a signal instructing the casting mold 102 and material injection system 108 to produce the castings. The controller 104 may include a programmable logic controller in one embodiment. During production a temperature of the casting mold 102 remains above an ambient temperature due to receiving molten metal from the material injection system 108 and retaining heat from the cooling casting. The beginning of the downtime event is a moment when the casting mold 102 is exposed to the ambient temperature and begins to drop in temperature. In the depicted embodiment, the beginning of the downtime event may occur when the casting mold 102 is opened and/or the casting is removed. The end of the downtime event is a moment when the casting mold 102 receives a source of heat and thus begins increasing in temperature. As depicted, the end of the downtime event may occur when the material injection system 108 begins injecting molten metal into the casting mold 102.

The material injection system 108 receives and forces, or injects, molten metal into the casting mold 102. The speed at which the molten metal is injected into the casting mold 102 is dependent on the design of the casting mold 102 and the type of casting being produced, among other factors. The material injection system 108 may inject the molten metal into the casting mold 102 at a higher speed when producing a casting during a production cycle than during the preheat cycle

The casting mold 102 receives molten metal from the material injection system 108 within an interior mold cavity and retains the molten metal in the shape of the mold cavity as it cools and hardens. The casting mold 102 may include a two-part mold to allow it to open and the casting to be removed from the casting. Additionally, the casting mold 102 may include an automatic mold opening mechanism to aid in opening the two-part mold at the end of a production cycle to allow for quick removal of the casting.

The transport mechanism 112 transports the hardened casting from the casting mold 102 to another operation, such as the recycling mechanism 106 or the subsequent manufacturing process 110. The transport mechanism 112 may include a conveyor system including a conveyor belt and rollers, a robot arm including a manipulator, or any other mechanism capable of transporting a part from the casting mold 102 to another operation.

The recycling mechanism 106 receives the casting from the die casting mold 102 via the transport mechanism 112. The casting is heated to a molten state for reuse in the die casting machine 100. In an exemplary embodiment, the recycling mechanism 106 is configured to recycle castings that include a single metal alloy, such as a preheat casting of an engine block that comprises an aluminum alloy material and is cast with aluminum cylinder liner sleeves. The depicted recycling mechanism 106 is not configured to recycle a production casting of the engine block that comprises an aluminum alloy material and is cast with steel cylinder liner sleeves. Alternative embodiments of the die casting machine 100 may include a recycling mechanism 106 that is configured to recycle castings that include different metal alloys (i.e., aluminum engine block cast with steel cylinder liner sleeves). By automatically transporting castings produced during the preheat cycle to the recycling mechanism 106, accidental delivery of castings produced during the preheat cycle to the subsequent manufacturing process 110 is prevented.

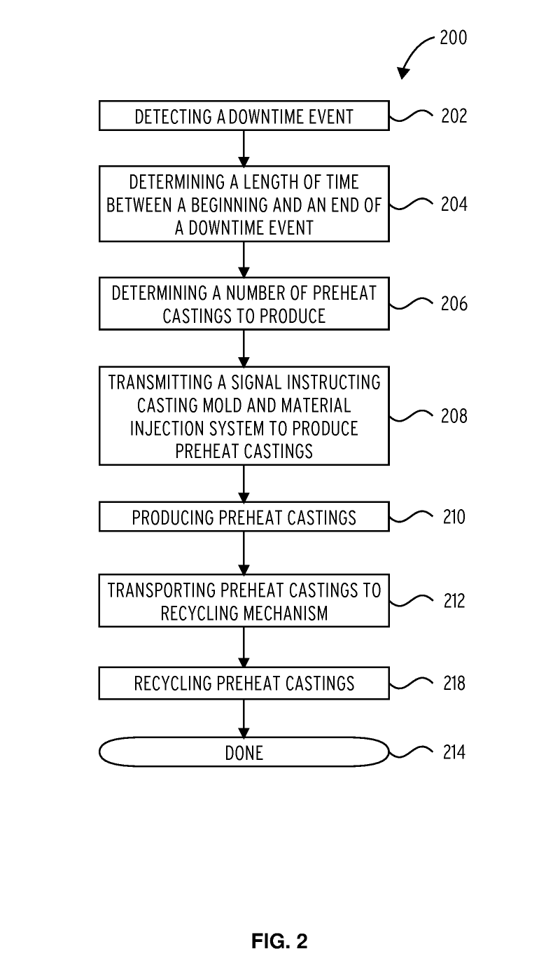

The subsequent manufacturing process 110 is reserved for castings produced from the die casting machine 100 during a production cycle, as described further with respect to FIG. 2. The subsequent manufacturing process 110 may include a further refining step, such as grinding, machining, drilling, tapping, deburring, boring, honing, or cleaning; or an assembly step.

FIG. 2 is a method for operating a die casting machine. In an exemplary embodiment, the die casting machine includes a controller, a casting mold, and a material injection system; method 200 is a die casting operation for producing an engine block and includes detecting 202 a downtime event, determining 204 a length of time between a beginning and an end of the downtime event, determining 206 a number of preheat castings to produce, transmitting 208 a signal instructing the die casting machine to produce the preheat castings, producing 210 the preheat castings, transporting 212 the preheat castings to a recycling mechanism, and recycling 218 the preheat castings.

Detecting 202 the downtime event is performed using the controller that is in signal communication with other components of the die casting machine, such as the casting mold and the material injection system. By monitoring an output of the components, the controller is able to determine whether the die casting machine is producing a casting or has stopped operation. Some examples of the downtime event are a production shift change or equipment failure.

Determining 204 the length of time between the beginning of the downtime event and the end of the downtime event includes measuring an elapsed time between the two events. This measurement may be performed by the controller incrementing a counter. Additionally, the beginning and the end of the downtime event may be identified by monitoring a signal output of at least one of the casting mold and the material injection system. In an exemplary embodiment, the length of the downtime event is measured in minutes, however the length of the downtime event may also be measured in seconds, fractions of a second, cycles, and/or any other duration-indicating units that allow the die casting machine to function as described herein.

Determining 206 the number of preheat castings to produce in a preheat cycle includes providing a length of time, verifying that the length of time is greater than or equal to a trigger value, performing a preheat casting quantity determination, and defining a preheat casting quantity. A preheat casting is a casting created during the preheat cycle to increase a temperature of the mold cavity. A production casting is a casting created after the preheat cycle and intended for use in an end product. The preheat casting is not subject to predetermined quality requirements as is a production casting, and often includes different design characteristics. The preheat casting of an exemplary engine block that includes a cylinder liner sleeve, for example, may include an aluminum alloy material for the engine block itself and also for the cylinder liner sleeve, while a production casting of the engine block may provide a steel cylinder liner sleeve in place of the aluminum alloy cylinder liner sleeve. The cylinder liner sleeve in the preheat casting is the same material as the engine block itself because the use of the same metal allows the casting to be melted in its entirety for reuse. The production casting typically requires the dissimilar metal (i.e., the steel cylinder liner sleeve) to be removed from the casting before it can be melted for reuse. Additionally, the preheat casting may be produced utilizing a slower shot speed of the material injection system since it is not subject to the quality requirements or a specific production cycle rate; the shot speed is a velocity in which molten metal is injected into the mold cavity.

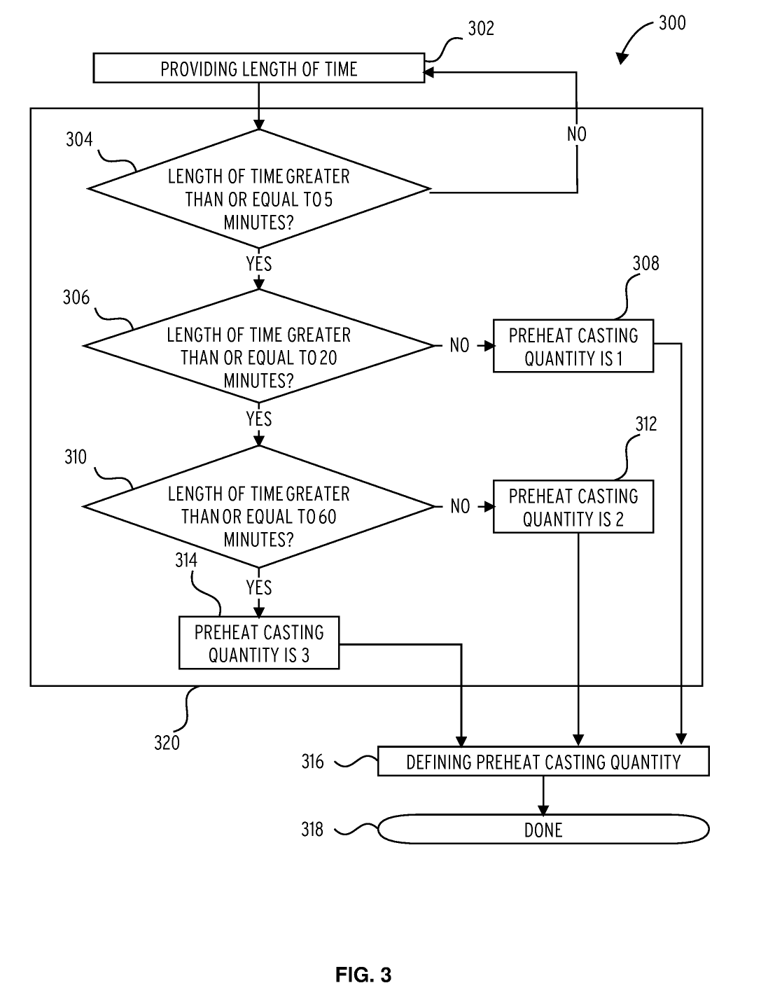

In an exemplary embodiment the trigger value is 5 minutes, however this value can vary dependent on the particular die casting machine in use. Comparison of the length of time versus the trigger value can be performed by the controller. The preheat casting quantity determination will be discussed further with regards to FIG. 3. Defining the preheat casting quantity includes obtaining an output value of the preheat casting quantity determination and assigning the value to a variable, or memory bit, designating the ideal preheat casting quantity for production, to be used in subsequent steps.

Transmitting 208 the signal instructing the casting mold and the material injection system to produce the defined number of preheat castings includes sending a signal to the die casting machine to begin operating the preheat cycle. This instruction may be provided by the controller to other components within the die casting machine. Producing 210 the preheat castings begins with the material injection system injecting molten metal into the casting mold.

An exemplary embodiment also includes automatically transporting 212 and recycling the preheat castings. Automatically transporting 212 the preheat castings includes transferring the preheat castings to a recycling mechanism after being produced. The transport can be performed using various methods such as a conveyor or a robot, depending on the configuration of the die casting machine and the design of the part. Recycling 218 the preheat castings includes heating the preheat castings until they reach a molten state for reuse in the die casting machine. Castings produced before and after the preheat cycle (i.e., production castings) may be automatically transported to a subsequent manufacturing process. The subsequent manufacturing process may include a further refining step, such as grinding, machining, drilling, tapping, deburring, boring, honing, or cleaning; or an assembly step.

FIG. 3 is a method for determining a number of preheat castings. In an exemplary embodiment, method 300 includes providing 302 a length of time, analyzing 320 the length of time, and defining 316 a preheat casting quantity. Providing 302 the length of time includes providing an elapsed time between the beginning and the end of a downtime event, similar to the length of time determined in 204 with regards to FIG. 2.

Analyzing 320 the length of time includes identifying the preheat casting quantity that is associated with a time range that contains the length of time. Analyzing 320 begins with decision block 304 that determines whether the length of time is less than 5 minutes. If the length of time is less than 5 minutes, method 300 returns to providing 302 the length of time. If the length of time is greater than or equal to 5 minutes, method 300 proceeds to decision block 306. Decision block 304 provides verification that the length of time has reached a trigger value, similar to the trigger value as defined with respect to FIG. 2, to signal that a preheat casting should be produced and a preheat cycle is needed.

Decision block 306 determines whether the length of time is greater than or equal to 20 minutes; if the length of time is less than 20 minutes, method 300 proceeds to block 308 wherein the preheat casting quantity is 1. If the length of time is greater than or equal to 20 minutes, method 300 proceeds to decision block 310. In decision block 310, if the length of time is less than 60 minutes method 300 proceeds to block 312 wherein the preheat casting quantity is 2. If the length of time is greater than or equal to 60 minutes, method 300 proceeds to block 314 wherein the preheat casting quantity is 3.

Method 300 continues by defining 316 the preheat casting quantity based on the analysis 320. Defining 316 the preheat casting quantity includes assigning the value obtained from the analysis 320 to a variable or memory bit. Although not shown in FIG. 3, the defined preheat casting quantity is subsequently communicated to components within a die casting machine, such as the material injection system 108 and/or the casting mold 102.

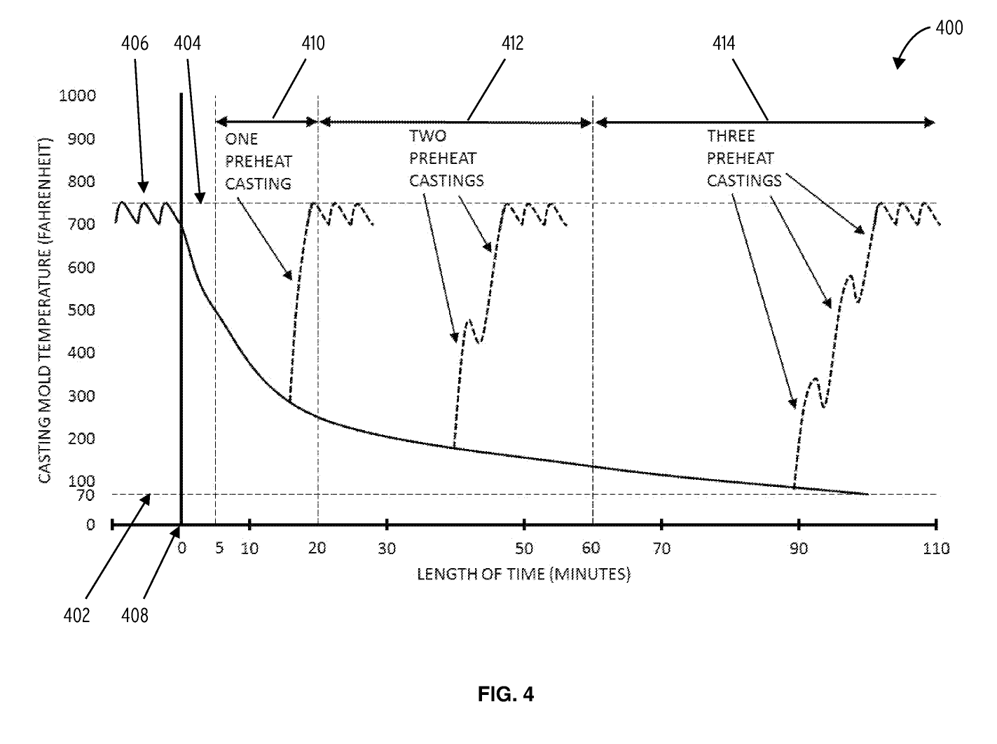

FIG. 4 is a chart 400 illustrating a length of time vs. a casting mold temperature according to the method 300 provided in FIG. 3. The values in the exemplary embodiment are provided for illustrative purposes only and may vary in other embodiments. As indicated, the chart shows the length of time of a downtime event vs. the temperature of the casting mold. The length of time is provided in minutes, and the temperature is provided in Fahrenheit. An ambient temperature 402 is approximately 70 degrees and an average production temperature 404 is approximately 750 degrees in the depicted embodiment. Although not shown, an average production temperature range may vary between approximately 400-900 degrees, and corresponds with a temperature range that produces an acceptable production casting. A higher ambient temperature 402, as well as a higher operation time of a die casting machine that includes the casting mold may result in a higher average production temperature 404.

In the depicted embodiment, the temperature of the casting mold during a production cycle 406 rises rapidly as the casting mold is injected with molten metal, and cools as the casting mold is opened and a production casting is removed. The cooling rate of the casting mold may be the same or slower than the heating rate. During a preheat cycle, wherein preheat castings are produced, the heating rate and cooling rate of the casting mold may be different than during the production cycle 406. This may be due to differences between the preheat cycle and the production cycle 406 related to the injection rate of the molten metal into the casting mold, or differences related to a removal speed of the casting from the casting mold.

When the die casting machine has ceased operation 408, the length of time begins incrementing from 0 minutes. At between approximately 0 and 5 minutes, no preheat castings will be produced. From approximately 5 to 20 minutes, referred to as Phase 1 410, 1 preheat casting will be produced. The preheat casting produced during Phase 1 410 will raise the temperature of the casting mold to near the average production temperature 404. After the number of preheat castings is produced, the remaining cycles depicted for each Phase 310, 312, 314 are production cycles and will continue until a further downtime event; for example, 2 production cycles are depicted for each Phase 310, 312, 314, however there is no specified limit to the number of production cycles. From approximately 20 to 60 minutes, referred to as Phase 2 412, 2 preheat castings will be produced. As shown, the first preheat casting is not sufficient to raise the temperature of the casting mold to the average production temperature 404 in Phase 2 412, however a second preheat casting will raise the temperature of the casting mold to near the average production temperature 404. From approximately 60 minutes and beyond, referred to as Phase 3 414, 3 preheat castings will be produced. Neither 1 nor 2 preheat castings are sufficient to raise the temperature of the casting mold to the average production temperature 404 in Phase 3 414, requiring a third preheat casting to raise the temperature of the casting mold to near the average production temperature 404. In Phase 3 414, prior to producing preheat castings, the casting mold temperature is approaching the ambient temperature 402 at which the temperature of the casting mold will remain constant. In other embodiments, the die casting machine may employ auxiliary heating for the casting mold, such as induction heating or water heating, to maintain a constant temperature of the casting mold higher than the ambient temperature 402.

The foregoing detailed description of exemplary embodiments is included for illustrative purposes only. It should be understood that other embodiments could be used, or modifications and additions could be made to the described embodiments. Therefore, the disclosure is not limited to the embodiments shown, but rather should be construed in breadth and scope in accordance with the recitations of the appended claims.

What is claimed is:

1. A method for operating a die casting machine comprising a controller, a casting mold, and a material injection system, the method comprising:
detecting a downtime event using the controller;
determining a length of time between a beginning of the downtime event and an end of the downtime event;
determining a number of preheat castings to produce in a preheat cycle; and
transmitting a signal instructing the casting mold and the material injection system to produce the number of preheat castings.

2. The method of claim 1, wherein detecting the downtime event comprises monitoring operation of at least one of the casting mold and the material injection system and determining when the die casting machine has stopped operating.

3. The method of claim 1, wherein determining the length of time comprises incrementing a counter between the beginning and the end of the downtime event.

4. The method of claim 3, wherein determining the length of time also comprises monitoring a signal output of at least one of the casting mold and the material injection system to identify the beginning and the end of the downtime event.

5. The method of claim 1, wherein the beginning of the downtime event is removal of a casting from the casting mold, and the end of the downtime event is operation of the material injection system.

6. The method of claim 1, wherein determining the number of preheat castings to produce in the preheat cycle includes correlating the length of time with the number of preheat castings that is known to increase a temperature of the casting mold to a production temperature.

7. The method of claim 6, wherein correlating the length of time comprises the following:
if the length of time is between approximately 5 minutes and 19 minutes, the number of preheat castings is 1;
if the length of time is between approximately 20 minutes and 59 minutes, the number of preheat castings is 2; and
if the length of time is approximately 60 minutes or greater, the number of preheat castings is 3.

8. The method of claim 1, wherein transmitting the signal comprises the controller sending a signal to at least one of the casting mold and the material injection system.

9. The method of claim 1, further comprising producing the number of preheat castings to complete the preheat cycle.

10. The method of claim 9, wherein the die casting machine is configured to produce an engine block.

11. The method of claim 10, further comprising inserting a cylinder liner into the casting mold prior to producing the number of preheat castings.

12. The method of claim 9, further comprising automatically transporting preheat castings produced in the preheat cycle to a recycling mechanism.

13. The method of claim 12, further comprising recycling the preheat castings by heating to a molten state.

14. The method of claim 1, further comprising automatically transporting castings produced after completion of the preheat cycle to a subsequent manufacturing process.

15. A die casting machine comprising,
a casting mold;
a material injection system in flow communication with the casting mold and configured to provide molten material to the casting mold; and
a controller in signal communication with the material injection system and the casting mold and configured to detect a downtime event, determine a length of time between a beginning of the downtime event and an end of the downtime event, determine a number of castings to produce in a preheat cycle, and transmit a signal instructing the casting mold and the material injection system to produce the number of castings.

16. The die casting machine of claim 15, wherein the casting mold comprises a two part mold and a mold opening and closing mechanism.

17. The die casting machine of claim 15, wherein the material injection system is configured to provide molten material to the casting mold at a slower rate in the preheat cycle than after completion of the preheat cycle.

18. The die casting machine of claim 15, further comprising a transport mechanism in signal communication with the controller and configured to remove a casting from the casting mold.

19. The die casting machine of claim 18, wherein the transport mechanism is configured to automatically transport castings produced in the preheat cycle to a recycling mechanism.

20. The die casting machine of claim 18, wherein the transport mechanism is configured to automatically transport castings produced after completion of the preheat cycle to a subsequent manufacturing process.
